(19) United States
(12) Patent Application Publication
(10) Pub. No.: US 2009/0316397 A1
(43) Pub. Date: Dec. 24, 2009

(54) LIGHT-EMITTING DEVICE

(75) Inventors: Marcellinus Petrus Carolus Michael Krijn, Eindhoven (NL); Ramon Pascal Van Gorkom, Eindhoven (NL)

Correspondence Address: Philips Intellectual Property and Standards, P.O. Box 3001, Briarcliff Manor, NY, 10510-8001, US

(73) Assignee: KONINKLIJKE PHILIPS ELECTRONICS N.V., Eindhoven (NL)

(21) Appl. No.: 12/373,902

(22) PCT Filed: Jul. 24, 2007
(86) PCT No.: PCT/IB07/52943

§ 371 Date: Jan. 15, 2009

(30) Foreign Application Priority Data
Jul. 31, 2006 (EP) 06118149.1

(51) Int. Cl. F21V 5/00

(52) U.S. Cl. 362/235

(57) ABSTRACT

A light-emitting device (100) comprising four light sources (101, 102, 103, 104) in quadrangular arrangement, and a collimating element (110) arranged to collimate and mix light emitted by said light sources is provided. The collimating element has a receiving side (111) for receiving light from said light sources and an opposite output side (112), and comprises two intersecting V-shaped profile surfaces (120, 130), the edges of said V-shaped profile surfaces (125, 135) being arranged towards said receiving face (111). The collimating element is capable of collimating the light from the four light sources and obtain a good color mixing, such that light from each light source is collimated to essentially the same degree.

### TECHNICAL FIELD

The present invention relates to a light-emitting device comprising four separate light sources in quadrangular arrangement and a light-collimating element arranged to collimate and mix the light emitted by said light sources.

The present invention also relates to the light collimating elements as such and display devices comprising light-emitting devices of the present invention.

### TECHNICAL BACKGROUND

Planar light sources are currently contemplated for several different applications, such as lamps for environmental illumination, backlights in liquid crystal displays and light sources in projection displays.

Light-emitting diodes, LEDs, may be a desirable choice of light sources in many applications, for example as the life time of LEDs are higher than the life time of incandescent bulbs, fluorescent bulbs and discharge lamps.

Further, light-emitting diodes are more power consumption efficient than incandescent bulbs and are expected to be more efficient than fluorescent tubes in a near future.

In several of these and other applications, it is often desired to achieve light of high brightness and color variability.

The brightness (B) is defined as being the amount of lumens (Φ) emitted per unit of area (A) and per unit of solid angle (Ω):

$$B = \frac{Φ}{A Ω} .$$

Conventionally, color variability is obtained by arranging a number of red, green, blue and amber LEDs in an array (rows, columns or a two-dimensional matrix) to form an array of color variable, independently addressable, pixels.

Color variable light of high brightness is typically obtained by stacking a high number of high-brightness LEDs, emitting in different parts of the spectrum, side by side in a matrix. The more LEDs being arranged on a certain area, the higher the ratio Φ/A becomes.

However, positioning LEDs that emit different colors side by side in itself is not an efficient way of obtaining light that is collimated as much as possible. Typically, LEDs emit light in an essentially Lambertian pattern, i.e. having an intensity proportional to the cosine of the angle from which it is viewed. Positioning LEDs of different colors side by side will again result in a Lambertian radiation pattern. Thus, the angular spread, proportional to Ω, is unchanged.

Conventionally, efficient collimation is obtained by leading un-collimated light into a funnel having reflective inner walls and which has a smaller cross section at the receiving side and a larger cross section at the output side. Thus, the collimator in general has an area larger than the area of the light source. Thus, by using conventional collimators, the light sources must be in spaced apart arrangement in order for the collimators to fit, which increases the area (A) in the formula above, leading to a decreased brightness.

Further, by arranging light sources in a spaced apart arrangement, the light mixing will be negatively affected.

US2004/0120647 A1, Sakata et al, describes an optical element for mixing light from three adjacent light sources, such as a red, a green and a blue light-emitting diode. The optical element includes a first optical wave guide having a first incidence plane on which first color light is incident and an emergence plane opposed to the first incidence plane; a second optical wave guide having a second incidence plane on which second color light is incident; a third optical wave guide having a third incidence plane on which third color light is incident, the second optical wave guide and the third optical wave guide being joined to the first optical wave guide; a first dichroic filter formed on a joint plane between the first optical wave guide and the second optical wave guide to reflect the first color light and the third color light and transmitting the second color light; and a second dichroic filter formed on a joint plane between the first optical wave guide and the third optical wave guide to reflect the first color light and the second color light and transmitting the third color light, the three colors light being emerged from the emergence plane of the first optical wave guide.

However, in such an arrangement, it is not straight forward to add a fourth light-emitting diode having a fourth color, and is a clear difference in degree of collimation between different colors, even without adding a fourth color.

### SUMMARY OF THE INVENTION

It is an object of the present invention to overcome the above-mentioned problems with the prior art, and to provide a light-emitting device comprising four light sources and a collimating structure which can collimate the light from the four light sources and obtain a good color mixing, such that light of each color is collimated to essentially the same degree.

Thus, in a first aspect, the present invention relates to a light-emitting device comprising four light sources in quadrangular arrangement, and a collimating element arranged to collimate and mix light emitted by said light sources, said collimating structure has a receiving side for receiving light from said light sources and an opposite output side. The collimating element comprises two intersecting V-shaped profile surfaces, where the edges of said V-shaped profile surfaces being arranged towards said receiving face, and the collimating element is arranged in front of said light sources, such that each of said light sources is located in rear of and outside a separate line of intersection between said two V-shaped profile surfaces. Each leg of said V-shaped surfaces is at least partly constituted by a dichroic filter that is transmissive for light from the pair of adjacent light sources arranged in rear of said leg, and that is reflective for light from the opposite pair of adjacent light sources.

The proposed arrangement results in a light-emitting device having a very compact structure that is capable of collimating and mixing light from four light-emitting diodes.

Effectively, the light from each light source is collimated by a separate funnel-like structure having a larger cross section at the output side than at the receiving side. However, at the output side, the four funnels overlap, and thus, the total cross section area of the four funnels is not necessarily larger than the cross section of one of these funnels. Thus, efficient collimation and mixing of light from four light sources can be obtained in a collimating element having an output area not bigger than the combined area of the light-sources.

In preferred embodiments of the present invention, the first leg of said first V-shaped profile surface is arranged in front of said first and second light sources, and is provided with a dichroic filter that is transmissive for light from said first and second light sources and reflective for light from said third and fourth light sources. The second leg of said first V-shaped profile surface is arranged in front of said third and fourth light sources, and is provided with a dichroic filter that is transmissive for light from said third and fourth light sources and reflective for light from said first and second light sources. The first leg of said second V-shaped profile surface is arranged in front of said first and third light sources, and is provided with a dichroic filter that is transmissive for light from said first and third light sources and reflective for light from said second and fourth light sources. Finally the second leg of said second V-shaped profile surface is arranged in front of said second and fourth light sources and is provided with a dichroic filter that is transmissive for light from said second and fourth light sources and reflective for light from said first and third light sources.

In embodiments of the present invention, the collimating structure may be arranged in a jacket comprising sidewalls. By encasing each separate light-emitting device in a jacket, all light that comes out from the device will come out at the output side of the collimating element. Thus, the light-leakage between adjacent light-emitting devices is minimized. Preferably, the surfaces of such jacket sidewalls facing the collimating structure are reflecting. When the inner surfaces of the jacket is reflective, essentially all light emitted by the light sources will be utilized and will come out at the output side of the collimating element

In embodiments of the present invention, the angle between the normal to the first leg of a V-shaped profile surface and the normal to the second leg of the same V-shaped profile element increases with the distance from said receiving face. An increasing angle with the distance implies that the legs of the profile surfaces has a curved cross-section. For example, this allows the V-shaped profile elements to have a parabolic-like shape for efficient collimation.

In embodiments of the present invention, the dichroic filters may comprise an interference stack of alternating layers of materials having different refractive indices. Interference stacks are highly efficient as dichroic filters because they have a typically nearly zero coefficient of absorption for all wavelengths of interest. Furthermore, they can be designed with many degrees of freedom (e.g. number of layers, layer thickness, materials choice).

In embodiments of the present invention, the refractive index of material located between said lines of intersection and said light sources has a refractive index of from 1.0 to 1.2. It is advantageous that the light from the light sources travels through a medium with n˜1 until it encounters a filter, since this ensures that when the light crosses the interface between this medium and the filter, the angle of the light is refracted towards the normal to the layers of the filters because the filters typically have an index of refraction of 1.4-1.8 (i.e. higher than air). In other words, this limits the angle with respect to the normal at which the light traverses the active layers of the filter. This is important since the behavior of dichroic filters may depend rather strongly on the angle of incidence of the light. Thus, a filter in air with good optical quality will be easy to design.

It is thus also preferred that the refractive index of material located in front of and inside the lines of intersection has a refractive index of from 1.0 to 1.2.

In embodiments of the present invention, the V-shaped profile surfaces may be constituted by self-supported wall-elements. When the dichroic filters are arranged on or as self-supporting wall-elements, the above desired refractive index can easily be obtained, for example by letting air be the propagation medium.

In a second aspect, the present invention relates to a light-collimating element for collimating light from four light sources.

In a third aspect, the present invention relates to a display device comprising at least two independently addressable light-emitting devices of the present invention.

### BRIEF DESCRIPTION OF THE DRAWINGS

These and other aspects of the present invention will now be described in more detail, with reference to the appended drawings showing a currently preferred embodiment of the invention.

FIG. 1 illustrates a currently preferred embodiment of a light-emitting device of the present invention.

FIG. 2 illustrates an alternative to the embodiment in FIG. 1.

FIG. 3 is a result graph from an experiment described below.

### DETAILED DESCRIPTION OF PREFERRED EMBODIMENTS

As used herein, the term “light source” relates to any kind of light source known to those skilled in the art. For example, the term relates to incandescent bulbs, discharge lamps and light-emitting diodes.

As used herein, “light-emitting diodes” relates to all different types of light-emitting diodes (LEDs), including organic based LEDs, e.g. polymeric based LEDs, and inorganic based LEDs, which in operating mode emits light of any wavelength or wavelength interval, from ultra violet to infrared. Light-emitting diodes, in the context of this application, are also taken to encompass laser diodes, i.e. light-emitting diodes emitting laser light. Light-emitting diodes suitable for use in the present invention include, but are not limited to, top-emissive, side-emissive and bottom-emissive light-emitting diodes.

As used herein, the color of a light-emitting diode, e.g. a “green light-emitting diode”, refers to the color, i.e. the wavelength range of the light emitted by the light-emitting diode in operational mode.

As used herein, the term “collimator” and related terms, such as “collimating means” refers to an element that is capable of receiving electromagnetic (EM) radiation, e.g. light in the interval from UV to IR, and improve the degree of collimation of the received EM-radiation (i.e. reduce the angular spread).

As used herein, the term “wavelength range” refers to both continuous and discontinuous wavelength ranges.

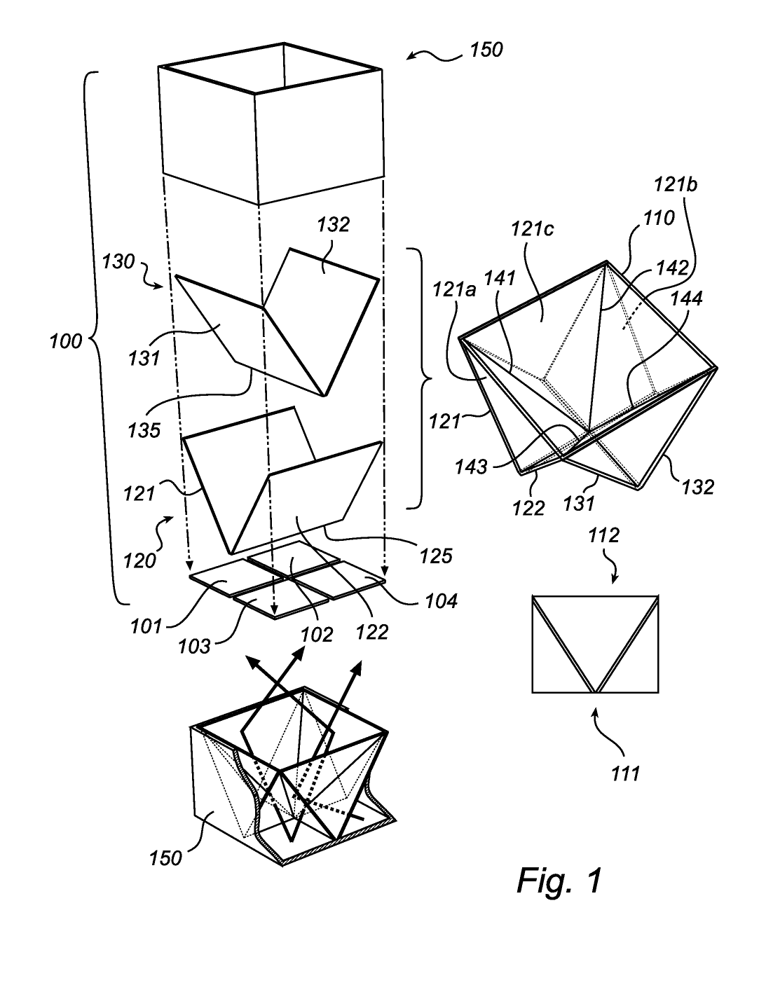

An exemplary embodiment of a light-emitting device 100 of the present invention is illustrated in FIG. 1 and comprises a first light-emitting diode 101, a second light-emitting diode 102, a third light-emitting diode 103 and a fourth light-emitting diode 104 in quadrangular arrangement, i.e. being arranged in a quadrangle constituted by 2×2 light-emitting diodes. In this exemplary embodiment, the four light sources emit light of different colors, for example, red, green, blue and amber. Further, the separate light sources may be independently addressable in order to yield a color variable light-emitting device.

The first light-emitting diode 101 and the second light-emitting diode 102 together forms a first side of the quadrangle. The third light-emitting diode 103 and the fourth light-emitting diode 104 together forms a second side of the quadrangle opposite to the first side. Further, the first light-emitting diode 101 and the third light-emitting diode 103 together forms a third side of the quadrangle, and the second light-emitting diode 102 and the fourth light-emitting diode 104 together forms a fourth side of the quadrangle, opposite to the third side.

A light collimating element 110 having a light receiving side 111 and a light output side 112 is arranged in front of the light-emitting diodes 101, 102, 103, 104 such that the light receiving side 111 faces the light-emitting diodes.

For the purposes of the present invention, directions and relative locations are indicated in relation to the main direction of light propagation within the device of the present invention, i.e. in the direction from the light sources towards the output side of the light-collimating element. Thus, “in front of” means closer to the output side of the light collimating element, and “in rear of” means closer to the light sources. Further, “in front of” and thereto associated terms, also relates to a first object being located “in front of” at least a portion of a second object, for instance being arranged in front of at least 30% of the area of the second object.

The collimating element 110 comprises of a first V-shaped profile surface 120 and a second V-shaped profile surface that intersects to form four separate lines of intersection 141, 142, 143 and 144.

Each of the V-shaped profile surfaces 120, 130 comprises a first leg 121, 131 and a second leg 122, 132, and an edge 125, 135 connecting the first leg 121, 131 to the second leg 122, 132.

The edges 125, 135 are arranged towards the light receiving side 111 of the light-collimating element 110, i.e. towards the light-emitting diodes.

The first leg 121 of the first profile surface 120 is arranged in front of the first light-emitting diode 101 and the second light-emitting diode 102. The second leg 122 of the first profile surface 120 is arranged in front of the third light-emitting diode 103 and the fourth light-emitting diode 104.

The first leg 131 of the second profile surface 130 is arranged in front of the first light-emitting diode 101 and the third light-emitting diode 103. The second leg 132 of the second profile surface 130 is arranged in front of the second light-emitting diode 102 and the fourth light-emitting diode 104.

Further, the first light-emitting diode 101 is arranged in rear of the line of intersection 141 between the first leg 121 of the first profile surface 120 and the first leg 131 of the second profile surface 130. The second light-emitting diode 102 is arranged in rear of the line of intersection 142 between the first leg 121 of the first profile surface 120 and the second leg 132 of the second profile surface 130. The third light-emitting diode 103 is arranged in rear of the line of intersection 143 between the second leg 122 of the first profile surface 120 and the first leg 131 of the second profile surface 130. The fourth light-emitting diode 104 is arranged in rear of the line of intersection 144 between the second leg 122 of the first profile surface 120 and the second leg 132 of the second profile surface 130.

The first leg 121 of the first V-shaped profile 120 surface is provided with a first dichroic filter that is transmissive for light emitted by the first and second light-emitting diodes 101, 102, but is reflective for light emitted by the diodes opposite to the first and second light-emitting diodes, i.e. the third and the fourth light-emitting diodes 103, 104.

The second leg 122 of the first V-shaped profile surface 120 is provided with a second dichroic filter that is transmissive for light emitted by the third and the fourth light-emitting diodes 103, 104, but is reflective for light emitted by the diodes opposite to the third and fourth light-emitting diodes, i.e. the first and second light-emitting diodes 101, 102.

The first leg 131 of the second V-shaped profile surface 130 is provided with a third dichroic filter that is transmissive for light emitted by the first and the third light-emitting diodes 101, 103, but is reflective for light emitted by the second and forth light-emitting diodes 102, 104.

The second leg 132 of the second V-shaped profile surface 130 is provided with a fourth dichroic filter that is transmissive for light emitted by the second and fourth light-emitting diodes 102, 104, but is reflective for light emitted by the first and third light-emitting diodes 101, 103.

A dichroic filter arranged on a leg of a V-shaped profile surface does not have to have the same properties over its whole extension. For example, it is possible that the filter has some different properties, with regards to transmission and reflection, in different domains of the leg. For instance, the first leg 121 of the first V-shaped profile surface 120 may be divided into three separate domains: a first domain 121a outside the first line of intersection 141 with the first leg 131 of the second V-shaped profile element 130, a second domain 121b outside the second line of intersection 142 with the second leg 132 of the second V-shaped profile element 130, and a third domain 121c between the above-mentioned first line of intersection 141 and the above-mentioned second line of intersection 142. As will be realized by those skilled in the art, the same holds, analogously, for both legs of both V-shaped profile surfaces.

In the present embodiment, the legs 121, 122, 131, 132 of the V-shaped profile surfaces are constituted by thin self-supporting wall elements, and the dichroic filters are arranged on the surfaces of these wall elements.

Thus, the medium through which light travels from the light source to the dichroic filters is typically air, vacuum or any other gaseous atmosphere.

Light from the first light-emitting diode 101 will pass through the first leg 121 of the first V-shaped profile surface 120 and the dichroic filter arranged thereon, and also pass through the first leg 131 of the second V-shaped profile surface 130 and the dichroic filter arranged thereon, but will be reflected on the dichroic filters arranged on the second leg 122 of the first V-shaped profile element and on the second leg 132 on of the second V-shaped profile element 130. As the second leg 122 of the first V-shaped profile element and the second leg 132 on of the second V-shaped profile element 130 are slanted away from the first light-emitting diode 101, the light thereof will be reflected thereon towards the output side 112 of the collimating element, and thus the light from this light-emitting diode will be collimated. As will be realized by those skilled in the art, an analogous reasoning can be performed also for the light from the second, third and fourth light-emitting diodes 102, 103, 104 of the light-emitting device of the present invention.

Thus, light from all four lights emitting diodes will be collimated and will exit the light-collimating element 110 through the output side 112 thereof. Thus, collimation and mixing is performed in the same structure.

In order to decrease the amount of light not exiting the collimating element 110 through the output side 112, sidewalls may be arranged as a jacket 150 on the vertical sides of the device. Thus, essentially all light that exits the device will do so through the output side 112. In order to further increase the light utilization efficiency of the device, the inner surfaces of such a jacket 150 may be reflective, such that light encountering such a sidewall will be reflected back into the collimating element 110 and eventually exit the device through the output side 112. Such reflective inner surfaces are preferably full spectrum reflecting for highest efficiency.

The jacket can be cylindrical, i.e. having parallel sidewalls, or may be tapered, especially such that the cross-section area of the jacket 150 is smaller at the receiving side 111 of the collimating element 110 and larger at the output side 112 of the collimating element 110. This will further enhance the collimation of the light. Further, the sidewalls of the jacket 150 may be straight or curved in respect of its extension from the receiving side to the output side of the collimating element 110. When the sidewalls are curved, the inner surfaces of the jacket 150 typically form a convex surface.

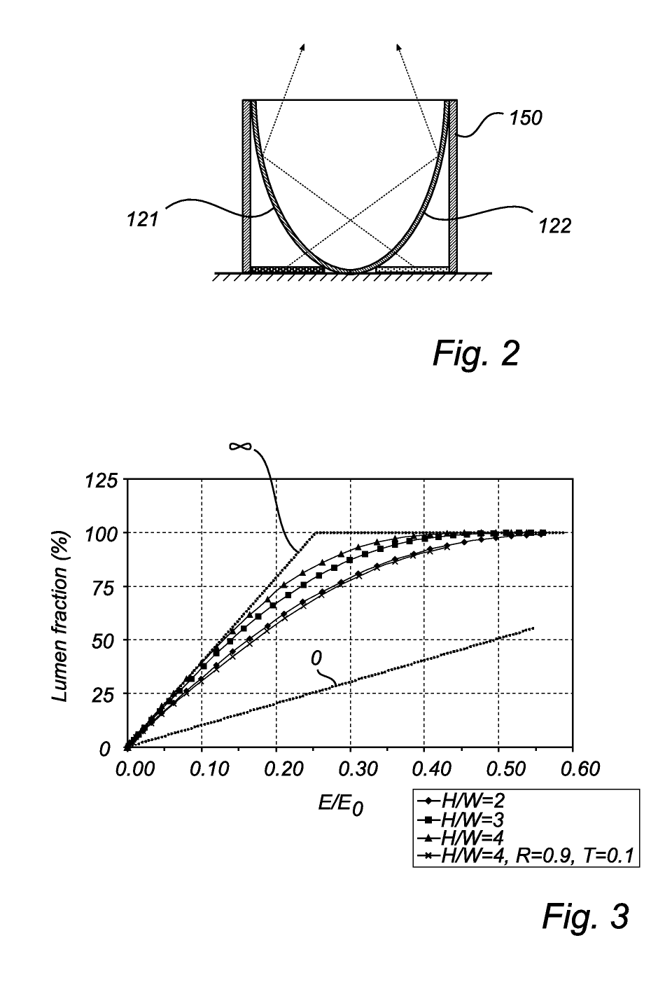

In alternative embodiments of the present invention, the legs of the V-shaped profile surfaces 120, 130 may have a curved cross-section, as is illustrated in FIG. 2. In such an embodiment, the angle between the normal of the first leg and the normal of the second leg increases along the main direction of light propagation. Thus, the term “V-shaped” profile surfaces, as used in the present invention also intends to encompass “U-shaped” profile surfaces.

By using such profile surfaces having legs with curved cross section, the collimation efficiency may be increased in that a certain degree of collimation may be achieved from a collimating element having a lower profile than a collimating element using profile surfaces having planar legs.

As used herein, the term “dichroic filter” relates to a filter that reflects electromagnetic radiation of one or more wavelengths or wavelength ranges, and transmits wavelengths or wavelength ranges, while maintaining a low, typically nearly zero, coefficient of absorption for all wavelengths of interest.

A dichroic filter may be of high-pass, low-pass, band-pass or band rejection type.

Dichroic filters suitable for use in a brightness enhancing means of the present invention include dichroic filters known to those skilled in the art, and include a multilayer of materials that differ in the index of refraction.

Examples of such dichroic filters include such filters commonly known as “interference stacks”, and comprise alternating layers of two or more materials having different index of refraction. For example, the thickness of each layer may typically be approximately equal to a quarter of the wavelength in air divided with the index of refraction, where the wavelength in air equals the dominant wavelength of the light for which the dichroic filter is adapted. One example of such an interference stack is made of alternating layers of Ta₂O₅ and SiO₂, but other material combinations are known to those skilled in the art.

Other examples of dichroic filters known to those skilled in the art and suitable for use in the present invention are such filters based on cholesteric liquid crystals, so called photonic crystals or holographic layers.

As used in the context of the present invention, a dichroic filter is matched to a lighting unit if the dichroic filter reflects wavelengths in the wavelength range emitted by the lighting unit while transmitting light of a different wavelength range.

For example, a dichroic filter adapted for green light may reflect green light while transmitting blue and red light.

It is not necessary that the emitted wavelength range and the reflected wavelength range are identical. The reflected wavelength range may for example be narrower than the emitted wavelength range, or may be broader than the emitted wavelength range.

Further, the dichroic filters may be non-ideal, i.e. not reflecting 100% of the light in the wavelength range in which the filter is to reflect light, and/or not transmitting 100% of the light in the wavelength range in which the filter is to transmit light. However, reflection and transmission efficiencies of above about 80%, such as about 90% is achievable.

Further, for ease of manufacturing, small holes may be present in the dichroic filters, or small gaps may be present between filters.

The height/width ratio of a light-emitting device of the present invention will influence the performance of the light-emitting device, as is shown in FIG. 3, showing results from ray-tracing simulations (ASAP) of a light-emitting device according to FIG. 1. In these calculations, the device was simulated as comprising four light sources each having an area of 1×1 mm, corresponding to the width W of 1 mm in the graph. The height is the height of the collimating element from the receiving side to the output side.

The simulations were performed for the height/width ratios H/W=0 (i.e. no collimating element), 2, 3, 4 and ∞ (i.e. a collimating element with infinite height).

The calculations were performed simulating dichroic filters having 100% transmission/reflection efficiency for H/W=0, 2, 3, 4 and ∞, and dichroic filters having 90% transmission/reflection efficiency.

As is clearly seen from the resulting graphs, the efficiency of the device increases with the H/W-ration, and also gives a marked efficiency increase even when non-ideal (“real”) filters are used.

Shown on the horizontal axis is the etendue E, relative to a reference etendue E₀. The reference etendue E₀ represents the case for which the dichroic filters are absent.

The graph represents the fraction of the light that is available within a certain etendue. Etendue is the product of the area (A) of the output side of the collimating element and the solid angle (Ω) of the light leaving the collimating element. In the figure, the etendue is varied by means of varying Ω and calculating for each value of Ω which fraction is leaving the collimating element within this Ω.

The person skilled in the art realizes that the present invention by no means is limited to the preferred embodiments described above. On the contrary, many modifications and variations are possible within the scope of the appended claims. For example, the present invention is not limited to that the legs of the V-shaped profile surfaces are constituted by self-supporting wall-element. In alternative embodiments, theses surfaces, on which the dichroic filters are arranged, may be the surfaces of solid wave-guide, either forming the interface between the wave-guide and the atmosphere or forming an interface to an adjacent solid wave-guide.

Further, an additional collimator may be arranged at the output side of the collimating element to further collimate light from the light-emitting device of the present invention.

Further, a light mixing means, typically in the form of a mixing rod which shape is adapted to the shape of the output side of the collimating element, may be arranged at the output side of the collimating element to further mix light from said collimating structure.

A light-emitting device of the present invention as a light source in many applications, for example, but not limited to, general lighting appliances, traffic lights, vehicle lights and display devices.

In an especially contemplated aspect, the present invention relates to a display device comprising two or more of the above-mentioned light-emitting devices. Typically in such display device, the light-emitting devices are independently addressable, for instance such that each light-emitting device, or a group of light-emitting devices represents a separate pixel of the display device. Light-emitting devices of the present invention may also serve as the light source in a projecting display device.

To summarize, the present invention relates to a light-emitting device comprising four light sources in quadrangular arrangement, and a collimating element arranged to collimate and mix light emitted by said light sources. The collimating element has a receiving side for receiving light from said light sources and an opposite output side, and comprises two intersecting V-shaped profile surfaces, the edges of said V-shaped profile surfaces being arranged towards said receiving face.

The collimating element is capable of collimating the light from the four light sources and obtain a good color mixing, such that light from each light source is collimated to essentially the same degree.

1. A light-emitting device comprising four light sources in quadrangular arrangement, and a collimating element arranged to collimate and mix light emitted by said light sources, said collimating structure having a receiving side for receiving light from said light sources and an opposite output side, wherein
said collimating element comprises intersecting first and second V-shaped profile surfaces, each V-shaped profile surface having a first leg and a second leg, the edges of said V-shaped profile surfaces being arranged towards said receiving face, and
said collimating element is arranged in front of said light sources, such that each of said light sources is located in rear of and outside a separate line of intersection between said two V-shaped profile surfaces, each leg of said V-shaped surfaces comprising a dichroic filter that is transmissive for light from the pair of adjacent light sources arranged in rear of said leg, and reflective for light from the opposite pair of adjacent light sources.

2. A light-emitting device according to claim 1, wherein
the first leg of said first V-shaped profile surface is arranged in front of said first and second light sources, and comprises a dichroic filter that is transmissive for light from said first and second light sources and reflective for light from said third and fourth light sources,
the second leg of said first V-shaped profile surface is arranged in front of said third and fourth light sources, and comprises a dichroic filter that is transmissive for light from said third and fourth light sources and reflective for light from said first and second light sources,
the first leg of said second V-shaped profile surface is arranged in front of said first and third light sources, and comprises a dichroic filter that is transmissive for light from said first and third light sources and reflective for light from said second and fourth light sources, and
the second leg of said second V-shaped profile surface is arranged in front of said second and fourth light sources and comprises a dichroic filter that is transmissive for light from said second and fourth light sources and reflective for light from said first and third light sources.

3. A light-emitting device according to claim 1, wherein said collimating structure is arranged in a jacket comprising side walls.

4. A light-emitting device according to claim 3, wherein surfaces of said jacket sidewalls facing the collimating structure are reflective.

5. A light-emitting device according to claim 1, wherein the angle between the normal to the first leg of said first or said second V-shaped profile surface and the normal to the second leg of the same V-shaped profile element increases with the distance from said receiving face.

6. A light-emitting device according to claim 1, wherein said filter comprises an interference stack of alternating layers of materials having different refractive indices.

7. A light-emitting device according to claim 1, wherein the refractive index of material located between said lines of intersection and said light sources has a refractive index of from 1.0 to 1.2.

8. A light-emitting device according to claim 1, wherein the refractive index of material located in front of and inside said lines of intersection has a refractive index of from 1.0 to 1.2.

9. A light-emitting device according to claim 1, wherein said V-shaped profile surfaces are constituted by self-supported wall-elements.

10. A light collimating element for collimating light from four light sources, said element having a receiving side and an output side and comprising two intersecting V-shaped profile surfaces, the edges of which are arranged towards said receiving side, wherein each leg of said V-shaped surfaces comprises a filter which is transmissive for light from a pair of adjacent light sources to be arranged under said leg, and reflective for light from a pair of light sources to be arranged under the opposite leg of the same profile surface.

11. (canceled)
